(19) United States
(12) Patent Application Publication
(10) Pub. No.: US 2011/0102350 A1
(43) Pub. Date: May 5, 2011

(54) METHOD FOR CONTROLLING OPERATIONS ACCORDING TO MECHANICAL TOUCHING ACTIONS AND PORTABLE ELECTRONIC DEVICE ADAPTED TO THE SAME

(75) Inventor: Hwi Gwon JUNG, Suwon-si (KR)

(73) Assignee: SAMSUNG ELECTRONICS CO. LTD., Suwon-si (KR)

(21) Appl. No.: 12/938,739

(22) Filed: Nov. 3, 2010

(30) Foreign Application Priority Data
Nov. 4, 2009 (KR) 10-2009-0105923

(51) Int. Cl. G06F 3/041

(52) U.S. Cl. 345/173; 178/18.03

(57) ABSTRACT

A method for controlling operations according to mechanical touching actions and a portable electronic device adapted to the method are provided. The portable electronic device includes a sensing unit for detecting a mechanical touching action and a location, to which the mechanical touching action is applied, and a type of mechanical touching action, a motion recognizing unit for identifying a motion scenario according to the identified location and the type of mechanical touching action, and a function conducting unit for performing a corresponding function of the portable electronic device according to the identified motion scenario.

### PRIORITY

This application claims the benefit under 35 U.S.C. §119(a) of a Korean patent application filed on Nov. 4, 2009 in the Korean Intellectual Property Office and assigned Serial No. 10-2009-0105923, the entire disclosure of which is hereby incorporated by reference.

### BACKGROUND OF THE INVENTION

1. Field of the Invention

The present invention relates to electronic systems. More particularly, the present invention relates to a method for controlling operations according to mechanical touching actions and a portable electronic device adapted to the method.

2. Description of the Related Art

Portable electronic devices refer to devices that can be transported and support a variety of user functions. Recently, the portable electronic devices have been widely used in various areas due to user convenience and portability. The portable electronic devices employ a variety of input methods in order to provide user functions.

Components to be installed in the portable electronic devices are manufactured small, so that users can conveniently transport the portable electronic devices. More particularly, an input unit for providing visual information to users is also reduced in size. In order to overcome size limitations of the input unit, conventional portable electronic devices have employed a touch screen comprised of a touch panel and a display panel, or have employed a keypad. However, conventional input units still require delicate and precise touching, or selecting operation. If a user does not correctly press or touch a key on the keypad, or an icon on the touch screen, the portable electronic device may perform a function that differs from the user's intent.

Therefore, a need exists for a portable electronic device and a method thereof for control touch operations on the portable electronic device.

### SUMMARY OF THE INVENTION

An aspect of the present invention is to address the above-mentioned problems and/or disadvantages. Accordingly, an aspect of the present invention is to provide a method for controlling operations according to mechanical touching actions and a portable electronic device adapted to the method.

In accordance with an aspect of the present invention, a method for controlling operations of a portable electronic device is provided. The method includes detecting a mechanical touching action applied to the portable electronic device, identifying a region to which the mechanical touching action is applied, and performing a function of the portable electronic device, corresponding to the identified region.

In accordance with another aspect of the present invention, a portable electronic device is provided. The device includes a sensing unit for detecting a mechanical touching action and creating a detected signal containing at least a region, to which the mechanical touching action is applied, and a type of mechanical touching action, a motion recognizing unit for identifying a motion scenario of the portable electronic device, corresponding to the detected signal output from the sensing unit, and a function conducting unit for performing a corresponding function of the portable electronic device, corresponding to the identified motion scenario.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a schematic block diagram illustrating a portable electronic device according to an exemplary embodiment of the present invention;

FIG. 2 is a detailed view illustrating a controller of a portable electronic device according to an exemplary embodiment of the present invention;

FIG. 3 is a flowchart illustrating a method for controlling operations of a portable electronic device according to an exemplary embodiment of the present invention;

FIG. 4 is a perspective view of a portable electronic device illustrating operations according to an exemplary embodiment of the present invention;

FIG. 5 is a perspective view of a portable electronic device illustrating an executed image view application according to an exemplary embodiment of the present invention;

FIG. 6 is a perspective view of a portable electronic device illustrating a displayed cube menu according to an exemplary embodiment of the present invention; and

FIG. 7 is a perspective view of a portable electronic device illustrating an executed multimedia player application to reproduce audio data, image data, or moving image data according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms or words used in the following description and the claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the claims and their equivalents.

It is to be understood that the singular forms “a,” “an,” and “the” include plural referents unless the context clearly dictates otherwise. Thus, for example, reference to “a component surface” includes reference to one or more of such surfaces

Exemplary embodiments of the present invention provide a portable electronic device. However, it should be understood that the present invention is not limited thereto. Accordingly, exemplary embodiments of the present invention can be applied to all information communication devices, multimedia devices, and their applications, such as, a mobile communication terminal, a Portable Multimedia Player (PMP), a Personal Digital Assistant (PDA), a smart phone, a Moving Picture Experts Group Audio Layer 3 (MP3) player, a mini Personal Computer (PC), and the like.

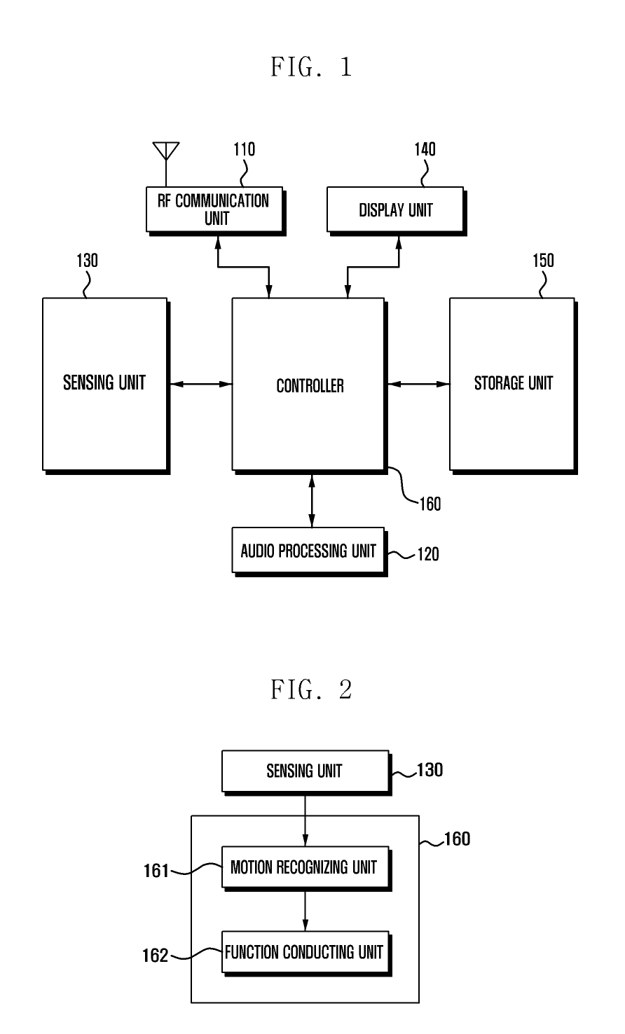

FIG. 1 is a schematic block diagram illustrating a portable electronic device according to an exemplary embodiment of the present invention.

Referring to FIG. 1, the portable electronic device includes an audio processing unit 120, a sensing unit 130, a display unit 140, a storage unit 150, and a controller 160. The portable electronic device may further include a Radio Frequency (RF) communication unit 110.

The portable electronic device creates a particular command for executing an application program to support the sensing unit 130, according to a user's request for a particular function, and allows the application processor to perform the particular function. That is, if a mechanical touching action, such as tapping, sweeping, and the like, has occurred in the portable electronic device, the portable electronic device creates a signal, based on a location, where the mechanical touching action has occurred, and the number of mechanical touching actions. Thereafter, the portable electronic device controls a currently executed application program using the created signal, operates a particular application program, or enters a particular operation mode. Each of the elements in the portable electronic device is described in more detail below.

The RF communication unit 110 wirelessly transmits and receives voice signals for a voice call and data for data communication to and from other external devices and communication systems, under the control of the controller 160. The RF communication unit 110 includes an RF transmitter (not illustrated) for up-converting the frequency of signals to be transmitted and amplifying the signals. The RF communication unit 110 also includes an RF receiver (not illustrated) for low-noise amplifying received RF signals and down-converting the frequency of the received RF signals. In an exemplary implementation, the RF communication unit 110 establishes a communication channel with other portable electronic devices under the control of the controller 160, and transmits and receives voice or video signals thereto and therefrom via the communication channel. The RF communication unit 110 may connect or disconnect a communication channel, based on a signal that is created by the mechanical touching action, where the mechanical touching action has occurred at a certain region (i.e., a location) of the portable electronic device.

The audio processing unit 120 reproduces audio data via a Speaker (SPK). The audio data contains an alarm sound, sound effects, and the like, according to the operations of the portable electronic device. Examples of the operations include a multimedia file playback, an operation of a corresponding unit, and the like. The audio data also contains data that are transmitted or received to or from an external device during the call. The audio processing unit 120 also acquires a user's voice during the call, audio sounds generated by an external device, and the like, via a Microphone (MIC). In an exemplary implementation, the audio processing unit 120 may play back or stop playing audio data, according to a signal that is created by the mechanical touching action on the certain region (i.e., the location) of the portable electronic device.

The sensing unit 130 may be implemented with a variety of sensors, such as an acceleration sensor, a gyro sensor, a terrestrial magnetic sensor, an image sensor, a touch sensor, and the like. The sensing unit 130 receives electrical power and operates under the control of the controller 160. The sensing unit 130 creates a detected signal according to the mechanical touching action that occurs on the certain region (i.e., the location) of the portable electronic device and outputs the detected signal to the controller 160. The sensing unit 130 may be implemented with an acceleration sensor, a gyro sensor, or a terrestrial magnetic sensor in order to detect vibration or impact when the mechanical touching action is applied to the portable electronic device. The sensing unit 130 may be implemented with the touch sensor, installed to the outer side of the portable electronic device, in order to detect a change in an electromagnetic field when the mechanical touching action is applied to the portable electronic device. More specifically, if the sensing unit 130 is implanted with an acceleration sensor, the sensing unit 130 creates a detected signal containing information regarding a change in acceleration when the mechanical touching action is applied to the portable electronic device and then outputs the detected signal to the controller 160. If the sensing unit 130 is implemented with a touch sensor, the sensing unit 130 creates a detected signal containing information regarding a location where a touch action has occurred and outputs the detected signal to the controller 160.

The display unit 140 outputs a variety of screens activated according to the functions of the portable electronic device, for example, a booting screen, an idle screen, a menu screen, a call screen, an application executing screen, and the like. The display unit 140 may be implemented with a Liquid Crystal Display (LCD). In this case, the display unit 140 may further include an LCD controller, a memory for storing data, an LCD display device, and the like. If the LCD is implemented as a touch screen, the display unit 140 may also serve as an input device. In an exemplary implementation, the display unit 140 may display a screen outputting a particular function or a screen executing a particular function when a particular function is activated, according to the region (i.e., the location) where a mechanical touching action has occurred or the type of mechanical touching action.

The storage unit 150 stores user data and application programs for operating the portable electronic device. Examples of the application programs may include an application program for operating user interface related to the touch screen, and an application program for recognizing mechanical touching actions that occurred in the portable electronic device, as corresponding input signals, and providing information for controlling corresponding functions. The storage unit 150 may also serve to buffer detected signals corresponding to mechanical touching actions. The storage unit 150 may include a program storage area and a data storage area.

The program storage area stores an Operating System (OS) for booting the portable electronic device, a touch User Interface (UI) operating program, an application program for operating the sensing unit 130, an application program for option functions, and the like. Examples of the option functions may include functions for reproducing audio data, a still image or moving images. In an exemplary implementation, the program storage area stores an application program for operating a variety of sensors included in the sensing unit 130, respectively, and an application program for recognizing a location where a mechanical touching action has occurred and a type of mechanical touching action via the sensing unit 130, as an input signal.

The data storage area stores data generated when the portable terminal 100 is operated or used. The data storage area also stores user data related to a variety of options provided by the portable electronic device, for example, moving images, phonebook data, audio data, information regarding contents, user data, and the like. The data storage area also stores the information regarding an application program executed in the portable electronic device and the control information regarding an application program according to a location where the mechanical touching action has occurred and the type of mechanical touching action. The application programs may also include a variety of application programs, serving as a multimedia player for images, moving images, audio data, and the like, and as a channel player for radio broadcasting and Digital Multimedia Broadcasting (DMB), and the like.

The controller 160 controls the supply of electrical power to the portable electronic device, the activation of elements included in the portable electronic device, and the signal flow among the elements. In an exemplary implementation, the controller 160 receives detected signals from the sensing unit 130. The detected signals contain information regarding a location where the mechanical touching action has occurred and the type of mechanical touching action. The controller 160 also calls or executes a particular application program, according to the detected signals. The controller 160 also executes or stops executing a particular function of a currently executed application, according to the detected signals. Accordingly, the controller 160 may include a motion recognizing unit 161 and a function conducting unit 162 as illustrated in FIG. 2.

The motion recognizing unit 161 recognizes a location where the mechanical touching action has occurred, the number of mechanical touching actions, a duration time of the mechanical touching action, direction of the mechanical touching action, and the like, based on the detected signals output from the sensing unit 130. The motion recognizing unit 161 receives detected signals from the sensing unit 130, detects a location where the mechanical touching action has occurred and the type of mechanical touching action, and outputs a corresponding motion signal to the function conducting unit 162.

For example, the motion recognizing unit 161 may determine whether the magnitude of the mechanical touching action is equal to or greater than a preset value, based on the detected signal, which region of the portable electronic device the mechanical touching action has occurred, whether the mechanical touching action is retained for a preset period of time, how many times the mechanical touching action has occurred within a preset time, and whether a movement motion has occurred while the mechanical touching action is being retained.

The function conducting unit 162 extracts a motion scenario from the storage unit 150, which matches the recognition result of the motion recognizing unit 161, and performs a function according to the extracted motion scenario. The function conducting unit 162 is described in more detail below.

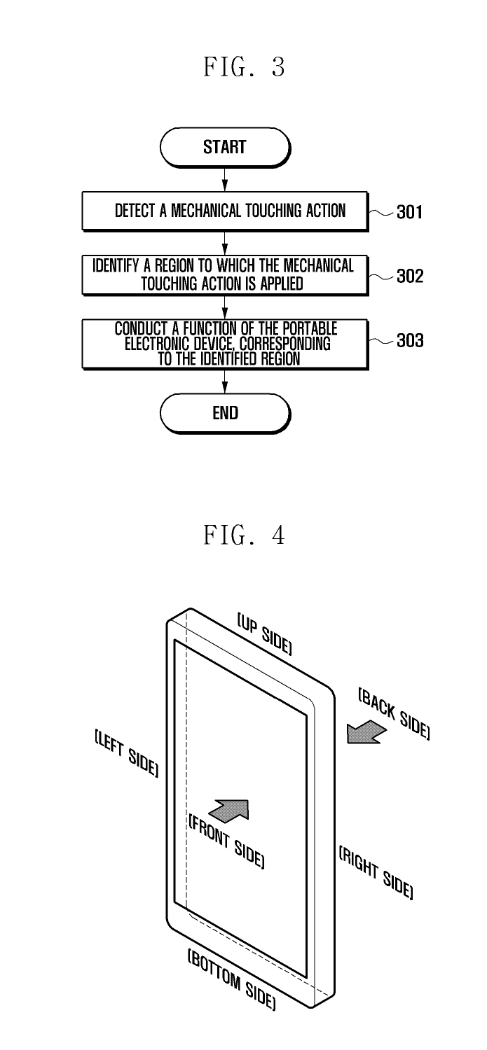

FIG. 3 is a flowchart illustrating a method for controlling operations of the portable electronic device according to an exemplary embodiment of the present invention. It is assumed herein that a mechanical touching action may be a tapping motion onto the portable electronic device.

Referring to FIG. 3, the controller 160 controls the sensing unit 130 to detect a user's mechanical touching action in step 301. If the user taps the portable electronic device, the sensing unit 130 creates a detected signal corresponding to the tap motion and outputs the detected signal to the controller 160. If the sensing unit 130 is implemented with an acceleration sensor, the sensing unit 160 creates a detected signal containing information regarding a change in acceleration and outputs the detecting signal to the controller 160. The controller 160 receives the detected signal and ascertains that a user conducted the mechanical touching action.

The motion recognizing unit 161 of the controller 160 identifies a region of the portable electronic device, to which the mechanical touching action is applied, based on the received detected signal in step 302. The motion recognizing unit 161 may detect which portion of the portable electronic device the mechanical touching action is applied based on the information regarding the change in the acceleration contained in the detected signal. In general, the portable electronic device is shaped as a rectangular parallelepiped. In an exemplary implementation, it is assumed that a front side of the portable electronic device refers to a side where the display unit 140 is located and a back side is opposite the front side. An upper side refers to an upper side wall of the portable electronic device, seen from the front side, where a speaker is located in an area above a microphone. Likewise, a lower side refers to a lower side wall of the portable electronic device, seen from the front side, where the speaker is located in an area above the microphone. The left and right sides refer to the left and right side walls of the portable electronic device, seen from the front side. The directions of the sides in the portable electronic device are illustrated in FIG. 4. Therefore, the motion recognizing unit 161 may detect the side of the portable electronic device to which the mechanical touching action is applied, via the detected signal.

The motion recognizing unit 161 may also detect the type of mechanical touching action, via the detected signal. For example, if the user applies a tap action to the portable electronic device, the motion recognizing unit 161 may detect the number of taping actions.

The function conducting unit 162 of the controller 160 receives the information regarding the region of the portable electronic device, to which the mechanical touching action is applied, from the motion recognizing unit 161 and performs a function corresponding to the received information in step 303. The storage unit 150 stores a motion scenario, matched with the region information of the portable electronic device. The function conducting unit 162 extracts a motion scenario from the storage unit 150, which corresponds to the region of the portable electronic device to which the mechanical touching action is applied, and performs a corresponding function.

FIG. 4 is a perspective view of a portable electronic device illustrating operations according to an exemplary embodiment of the present invention.

Referring to FIG. 4, the motion recognizing unit 161 informs the function conduction unit 162 that a tap action is input to the front side of the portable electronic device. The function conducting unit 162 performs a function, according to the motion scenario corresponding to the tap action that is input to the front side.

The motion recognizing unit 161 outputs information regarding the type of mechanical touching action to the function conducting unit 162, so that the function conducting unit 162 may perform a function corresponding to the information regarding the type of mechanical touching action. The storage unit 150 stores the motion scenario, matching with the type of mechanical touching action. The function conducting unit 162 extracts a motion scenario from the storage unit 150 and performs a corresponding function. The type of mechanical touching action may be the number of tapping actions. In this case, the motion recognizing unit 161 outputs information regarding the number of tapping actions, input to the portable electronic device, to the function conducting unit 162, so that the function conducting unit 162 may extract the motion scenario, corresponding to the received information regarding the number of tapping actions, from the storage unit 150 and may perform a corresponding function.

The motion recognizing unit 161 outputs the information regarding the region of the portable electronic device, to which the mechanical touching action is applied, and information regarding the type of mechanical touching action to the function conducting unit 162, so that the function conducting unit 162 may perform a corresponding function according to the received information. For example, if the motion recognizing unit 161 outputs information regarding a side of the portable electronic device to which the tapping action is applied and information regarding the number of tapping actions to the function conducting unit 162, the function conducting unit 162 extracts the motion scenario corresponding to the information from the storage unit 150 and performs the corresponding function. The corresponding function may be a function to execute a particular application or a function that is performed when a particular application program is executed.

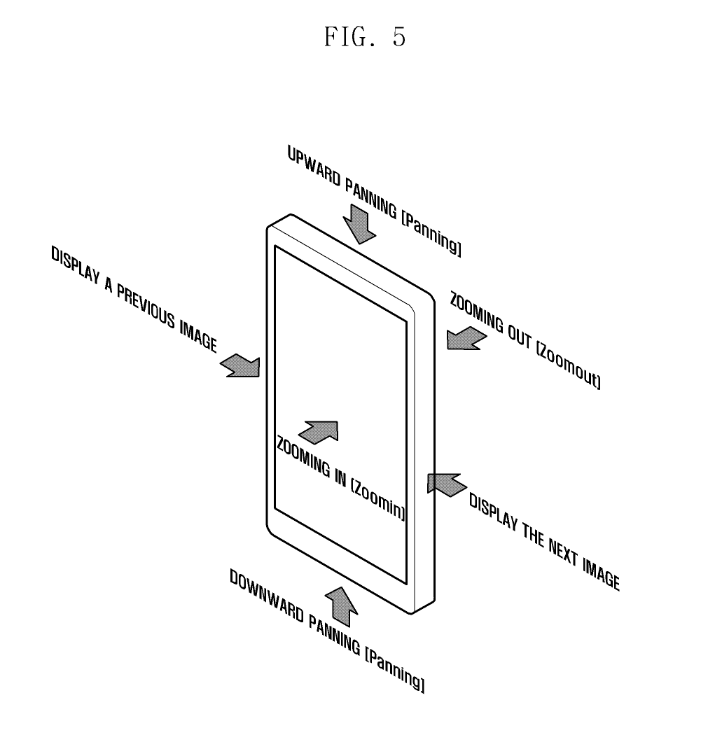

FIG. 5 is a perspective view of a portable electronic device illustrating an executed image view application according to an exemplary embodiment of the present invention. While the image view application program is being executed and thus an image is being displayed on the portable electronic device, a user may tap the portable electronic device.

Referring to FIG. 5, if the user taps a front side of the portable electronic device, the portable electronic device zooms in on a currently displayed image. On the contrary, if the user taps a back side of the portable electronic device, the portable electronic device zooms out on a currently displayed image. Likewise, when the user taps an upper side of the portable electronic device, the portable electronic device pans to a currently displayed image in an upper direction. On the contrary, when the user taps a lower side of the portable electronic device, the portable electronic device pans to a currently displayed image in a lower direction. Similarly, when the user taps a left side of the portable electronic device, the portable electronic device displays a previous image on the screen. On the contrary, when the user taps a right side of the portable electronic device, the portable electronic device displays the next image on the screen. Although the functions have been explained based on a portrait mode of the portable electronic device, it should be understood that the functions may also be applied the same way on a landscape mode.

Therefore, the portable electronic device may allow the user to control the image view function without using a key input unit, a touch screen, and the like.

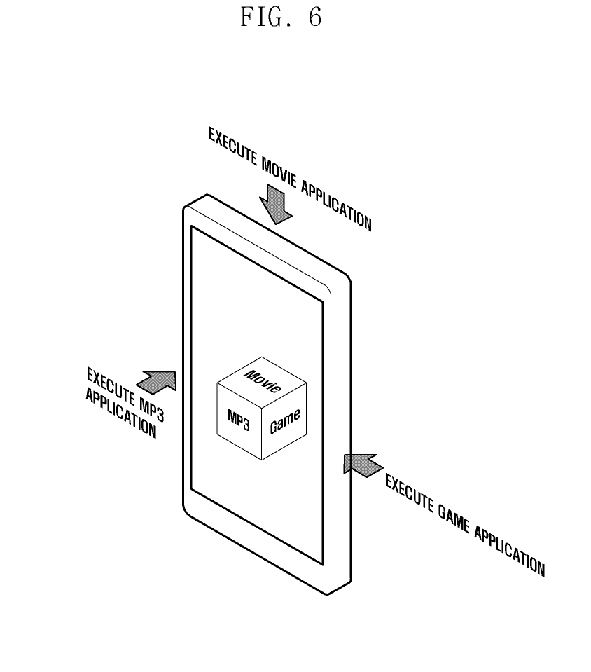

FIG. 6 is a perspective view of a portable electronic device illustrating a displayed cube menu according to an exemplary embodiment of the present invention. While the cube menu is being displayed in the portable electronic device, a user may control the operations of the portable electronic device according to applied tap actions.

Referring to FIG. 6, when the user taps a front side of the portable electronic device, the portable electronic device executes an MP3 function illustrated on a front surface of the cube menu. Likewise, when the user taps an upper side of the portable electronic device, the portable electronic device executes a movie function illustrated on an upper surface of the cube menu. In addition, when the user taps a right side of the portable electronic device, the portable electronic device executes a game function illustrated on a right surface of the cube menu.

Therefore, the portable electronic device may allow the user to illustrate a surface of the cube or execute a function corresponding to the surface of the cube, without directly inputting an instruction to the cube menu, irrespective of the illustrated direction of the cube menu.

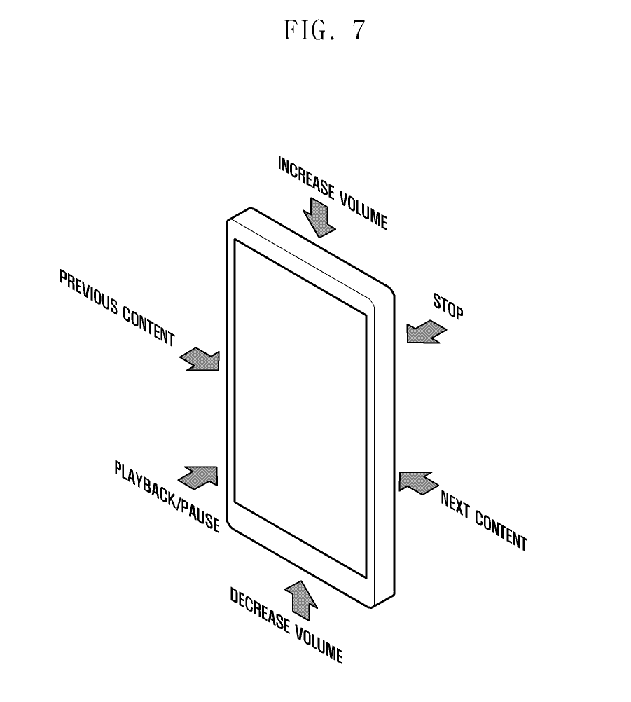

FIG. 7 is a perspective view of a portable electronic device illustrating an executed multimedia player application to reproduce audio data, image data, or moving image data according to an exemplary embodiment of the present invention. While the multimedia player application is being executed and corresponding content is played back in the portable electronic device, a user may control operations of the portable electronic device according to applied tap actions.

Referring to FIG. 7, when the user taps a front side of the portable electronic device, the portable electronic device pauses or resumes currently reproduced content. On the contrary, when the user taps a back side of the portable electronic device, the portable electronic device stops reproducing the currently reproduced content. Likewise, when the user taps an upper side of the portable electronic device, the portable electronic device increases the volume of the currently reproduced content. On the contrary, when the user taps a lower side of the portable electronic device, the portable electronic device decreases the volume of the currently reproduced content. Similarly, if the user taps a left side of the portable electronic device, the portable electronic device executes the previous content. On the contrary, if the user taps a right side of the portable electronic device, the portable electronic device executes the next content.

Although exemplary embodiments of the present invention have been described based on some functions, it should be understood that the present invention may also be applied to the control of an idle screen, a web browser and a message window, a function for making or receiving a call, an operation of main menus, and the like.

As described above, the portable electronic device, according to the exemplary embodiments of the present invention, can be easily controlled by a user's mechanical touching action.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for controlling operations of a portable electronic device, the method comprising:
detecting a mechanical touching action applied to the portable electronic device;
identifying a region to which the mechanical touching action is applied; and
performing a function of the portable electronic device, corresponding to the identified region.

2. The method of claim 1, further comprising:
identifying a type of mechanical touching action.

3. The method of claim 2, wherein the function of the portable electronic device corresponds to a function that is set according to the identified region, to which the mechanical touching action is applied, and the identified type of mechanical touching action.

4. The method of claim 1, wherein the detecting of the mechanical touching action comprises measuring at least one of a change in vibration and a change in an electromagnetic field, which are generated according to the mechanical touching action.

5. The method of claim 1, wherein:
the portable electronic device is shaped as a rectangular parallelepiped; and
the region corresponds to one of six sides forming the body of the portable electronic device, to which the mechanical touching action is applied.

6. A portable electronic device comprising:
a sensing unit for detecting a mechanical touching action and creating a detected signal containing at least a region, to which the mechanical touching action is applied, and a type of mechanical touching action;
a motion recognizing unit for identifying a motion scenario of the portable electronic device, corresponding to the detected signal output from the sensing unit; and
a function conducting unit for performing a corresponding function of the portable electronic device, corresponding to the identified motion scenario.

7. The portable electronic device of claim 6, wherein the sensing unit comprises at least one of a sensor for detecting a change in a vibration generated according to the mechanical touching action and a sensor for detecting a change in an electromagnetic field according to the mechanical touching action.

8. The portable electronic device of claim 6, wherein the motion recognizing unit recognizes a location where the mechanical touch action has occurred, the number of mechanical touch actions, a duration time of the mechanical touch action, and direction of the mechanical touch action based on the detected signal.

9. The portable electronic device of claim 6, wherein the motion recognizing unit receives detected signals from the sensing unit, detects a location where the mechanical touch action has occurred, detects the type of mechanical touch action, and outputs a corresponding motion signal to the function conducing unit.

10. The portable electronic device of claim 6, wherein the function conducing unit extracts the motion scenario from a storage unit and matches a recognition result of the motion recognizing unit, and performs a function corresponding to the extracted motion scenario.

11. A method for controlling operations of a portable electronic device, the method comprising:
creating a detected signal in response to a mechanical touching action applied to the portable electronic device;
identifying a region to which the mechanical touching action is applied;
receiving region information to which the mechanical touching action is applied; and
performing a function of the received region information.

12. The method of claim 11, further comprising:
identifying the type of mechanical touching action.

13. The method of claim 12, further comprising:
detecting which portion of the portable electronic device the mechanical touching action is applied based on the change in the acceleration.

14. The method of claim 12, wherein the function of the portable electronic device corresponds to a function that is set according to the identified region, to which the mechanical touching action is applied, and the identified type of mechanical touching action.

15. The method of claim 11, wherein the mechanical touching action results from at least one of a change in vibration and a change in an electromagnetic field.

16. The method of claim 11, wherein:
the portable electronic device is shaped as a rectangular parallelepiped; and
the region corresponds to one of six sides forming the body of the portable electronic device, to which the mechanical touching action is applied.
